(19) United States
(12) Patent Application Publication
(10) Pub. No.: US 2024/0393013 A1
(43) Pub. Date: Nov. 28, 2024

(54) ELECTRIC HEATER FOR THERMAL ENERGY STORAGE

(71) Applicant: VITAL ENERGI SOLUTIONS LIMITED, Blackburn (GB)

(72) Inventors: Yulong DING, Birmingham (GB); Abdalqader AHMAD, Birmingham (GB); Maria NAVARRO RIVERO, Birmingham (GB); Yelaman MAKSUM, Birmingham (GB)

(21) Appl. No.: 18/665,027

(22) Filed: May 15, 2024

(30) Foreign Application Priority Data
May 25, 2023 (GB) GB2307825.6

(51) Int. Cl. F24H 7/04; F24H 15/208; F24H 15/325; F28D 20/00

(52) U.S. Cl. CPC F24H 7/0416; F24H 15/208; F24H 15/325; F28D 20/00; F28D 2020/0013

(57) ABSTRACT

A plurality of electric heater elements are positioned within a core of an electric heater for heating the core to charge the core with stored thermal energy. A first air path extends through the core between an air input opening and an air output opening in a housing. An air supply conduit connects to a supply of an external air flow; an outlet end of an air output conduit is connected to a heated air outlet conduit, for outputting heated air from the electric heater. A bypass conduit connects first and second junctions and defines a second air path external of the core. A temperature sensor senses temperature of heated air. An air flow control valve mechanism variably controls a flow rate of air flow along a conduit based on a temperature of the heated air measured by the temperature sensor, thereby controlling a flow rate along the air paths.

### CROSS REFERENCE TO RELATED APPLICATION

This application claims the benefit of United Kingdom Application No. GB2307825.6, filed May 25, 2023. The entire content of the above-referenced application is hereby incorporated by reference.

### TECHNICAL FIELD

The present invention relates to an electric heater for thermal energy storage.

### BACKGROUND

Electric storage heaters have been known for many years. These heaters are designed to store thermal energy by charging a thermal energy storage medium with thermal energy by heating the medium using electric heater elements, and then subsequently the stored thermal energy is progressively discharged to heat a room, office, etc. Electric storage heaters are typically thermally charged when the unit cost of electricity is relatively low, for example at night when electricity demand is reduced, and the thermal discharge, which does not require significant consumption of electricity, occurs during the subsequent daytime period. The thermal discharge is by thermal conduction, radiation, and convection.

Conventional electric storage heaters use bricks composed of a refractory material to store thermal energy. These conventional electric storage heaters suffer from the problem of excessive and high manufacturing cost for a given thermal storage capacity. The energy storage density, expressed in Watt-hours per kilogram, is low, for example typically lower than 130 Wh/kg. A typical known commercial domestic storage heater with a storage capacity of about 10 kWh has a weight of at least 80 kg. Such a high weight increases the cost of manufacturing, transportation and delivery, and increases installation costs, and can also restrict locations where the storage heater can be installed.

It is also known to persons skilled in the art of thermal storage to use a phase change material (PCM) as a thermal energy storage medium. For example, U.S. Pat. No. 10,203,165 discloses a climatic apparatus for storing thermal energy using a phase change material.

However, there exists a need in the art for an electric storage heater which has low manufacturing cost and complexity, and low weight, and can exhibit enhanced performance, including a thermostatically controllable constant output temperature over an extended discharge period and a higher energy storage density, as compared to known electric storage heaters, in particular for domestic storage heaters used in domestic residences and office premises.

There also exists a need in the art for an electric storage heater which uses a phase change material (PCM) as a thermal energy storage medium, but has low complexity and manufacturing cost, and can exhibit enhanced performance, in particular for domestic storage heaters used in domestic residences and office premises.

The present invention aims to meet at least some of these needs in the art.

Therefore, it is an aim of the present invention to provide electric storage heaters which can exhibit enhanced performance, including a thermostatically controllable constant output temperature over an extended discharge period, a high energy storage density, and a low manufacturing cost and complexity.

### SUMMARY

Accordingly, in one aspect there is provided an electric heater for thermal energy storage, the electric heater comprising:
a core comprising a phase change material having a composition which absorbs or releases heat isothermally, or substantially isothermally, by transitioning, in a respective transition direction, between a first phase state and a second phase state at a predetermined transition temperature;
a plurality of electric heater elements positioned within the core for heating the core to charge the core with stored thermal energy by transitioning the phase change material from the first phase state to the second phase state;
a housing surrounding the core and defining a cavity within which the core is disposed, the housing having an air input opening connected to an output end of an air input conduit and an air output opening connected to an input end of an air output conduit, and a first air path extending through the core between the air input opening and the air output opening;
an air supply conduit for connection to a supply of an external air flow, wherein an inlet end of the air input conduit is connected to the air supply conduit at a first junction;
a heated air outlet conduit for outputting heated air from the electric heater, wherein an outlet end of the air output conduit is connected to the heated air outlet conduit at a second junction;
a bypass conduit connecting the first and second junctions and defining a second air path external of the core;
a temperature sensor for sensing the temperature of heated air in the heated air outlet conduit, or downstream of the heated air outlet conduit in the direction of air flow through the heated air outlet conduit; and
an air flow control valve mechanism in at least one of the bypass conduit and the air input conduit for variably controlling a flow rate of air flow along the bypass conduit and/or the air input conduit based on the temperature of the heated air measured by the temperature sensor, thereby variably to control the ratio of the volume flow rate of air along the first and second air paths.

According to a more specific aspect he the housing may define an input manifold, on an air input side of the core, which is in communication with the air input opening, and an output manifold, on an air output side of the core, which is in communication with the air output opening, and a plurality of air channels extend through the core between the input and output manifolds to form the first air path.

The air channels may form an array of parallel air channels. The air channels may be horizontally oriented and are mutually spaced in a height direction of the core. The air channels may be centrally located across a width direction of the core.

The core may comprise a plurality of heater bores which extend along the core, and a respective one of the electric heater elements is received in and extends along each respective heater bore, wherein at least some of the air channels are located between, and laterally spaced from, a plurality of the heater bores which are located, in a width direction of the core, on respective opposite lateral sides of the air channel and are spaced along a height direction of the core. At least some of the air channels may be centrally located between, and laterally spaced from, first and second pairs of the heater bores, wherein the first and second pairs are spaced from each other in the height direction of the core and in each of the first and second pairs the heater bores are spaced from each other in the width direction of the core and are located on respective opposite lateral sides of the core. The core may be formed as a continuous body with only the air channels and heater bores extending through the continuous body. The continuous body may be assembled from a plurality of blocks of phase change material.

The input manifold can have a first end adjacent to the air input opening and a second end remote from the air input opening along a length direction of the input manifold wherein the input manifold successively communicates with the plurality of air channels which are spaced along the length of the input manifold. The output manifold has a first end adjacent to the air output opening and a second end remote from the air output opening along a length direction of the output manifold wherein the output manifold successively communicates with the plurality of air channels which are spaced along the length of the output manifold. The first end of the input manifold may be lower than the second end of the input manifold. The first end of the output manifold may be higher than the second end of the output manifold. The first end of the input manifold may be lower than the second end of the input manifold. The first end of the output manifold may be lower than the second end of the output manifold.

The input manifold may progressively decrease in depth, in a direction transverse to the length direction of the input manifold, from the first to second ends of the input manifold. The output manifold may progressively increase in depth, in a direction transverse to the length direction of the output manifold, from the second to first ends of the output manifold.

The input manifold may progressively decrease in depth, in a direction transverse to the length direction of the input manifold, from the first to second ends of the input manifold. The output manifold may have a constant depth, in a direction transverse to the length direction of the output manifold, from the second to first ends of the output manifold.

The input manifold may have a constant depth, in a direction transverse to the length direction of the input manifold, from the first to second ends of the input manifold. The output manifold may have a constant depth, in a direction transverse to the length direction of the output manifold, from the second to first ends of the output manifold.

The electric heater may comprise a gate mechanism at the second junction, wherein the gate mechanism is configured to be switched between a thermal charging configuration, in which the outlet end of the air output conduit is closed, or substantially closed, and the heated air outlet conduit only, or primarily, receives air flow from the bypass conduit, and a thermal discharging configuration, in which the outlet end of the air output conduit is open and the heated air outlet conduit receives a mixed air flow from the air output conduit and the bypass conduit.

The gate mechanism may be configured to be switchable to an intermediate configuration which partly closes the outlet end of the air output conduit so that the core can be simultaneously thermally charged and thermally discharged, and the degree of closure and opening of the outlet end of the air output conduit can be varied across a desired range to enable the thermal storage and thermal output to be varied as desired.

The gate mechanism may be configured to cause the outlet end of the air output conduit to be continuously open by at least a minimum threshold amount, so that when the outlet end of the air output conduit is substantially closed, the electric heater is capable of continuous thermal discharge at least at a minimum output level.

The gate mechanism may comprise a slidable plate which is controlled by an actuator and is configured to be translationally slid between a first translational position in the thermal charging configuration to at least substantially cover the outlet end of the air output conduit and a second translational position in the thermal discharging configuration to expose the outlet end of the air output conduit.

The housing may include thermally insulative material which at least partly surrounds the phase change material.

The electric heater may comprise an air blower fitted to the air supply conduit for blowing the external air flow into the air supply conduit, and a controller for operating the air blower during a thermal discharging operation.

The temperature sensor may be controllable to vary the output temperature of the heated air outputted from the electric heater during a thermal discharging operation.

The electric heater may further comprise an external casing which encloses at least the housing, the bypass conduit and the valve mechanism, and the external casing comprises an air duct in communication with the heated air outlet conduit, and an array of air outlet vents in the external casing which form an air outlet of the air duct.

The phase change material can have a latent heat of from 100 to 800 KJ/kg for the transition between the first and second phase states at the predetermined transition temperature. According to a more specific example the latent heat is from 180 to 300 KJ/kg,

The core can have an energy storage density of from 140 to 300 Wh/kg. According to a more specific example this can be from 160 to 250 Wh/kg.

The core can have an energy storage capacity of from 2 to 50 kWh.

The predetermined transition temperature of the phase change material can within the range of from 200 to 750° C. According to a more specific example this can be from 300 to 750° C.

The phase change material can comprise a composite phase change material which comprises an inorganic material as a phase change composition, a structural material for structurally shape-stabilising the phase change material; and a heat transfer enhancement material dispersed in the phase change material. The structural material may comprise an alkaline earth metal oxide and the heat transfer enhancement material comprises graphite, carbide, metal or metal oxide, or a mixture of any two or more thereof.

In accordance with another aspect there is provided a thermal energy storage for an electric heater comprising:
a core comprising a phase change material having a composition which absorbs or releases heat isothermally, or substantially isothermally, by transitioning, in a respective transition direction, between a first phase state and a second phase state at a predetermined transition temperature;
a plurality of electric heater elements positioned within the core for heating the core to charge the core with stored thermal energy by transitioning the phase change material from the first phase state to the second phase state;
a plurality of air channels extending through the core between opposite input and output sides of core to form an air path through the core for heating air flowing through the air channels in a thermal discharge phase; and
a plurality of heater bores which extend along the core, a respective one of the electric heater elements being received in and extending along each respective heater bore, wherein at least some of the air channels are located between, and laterally spaced from, a plurality of the heater bores which are located, in a width direction of the core, on respective opposite lateral sides of the air channel and are spaced along a height direction of the core, and the core is formed as a continuous body with only the air channels and heater bores extending through the continuous body.

The air channels may form an array of parallel air channels. The air channels may be horizontally oriented and are mutually spaced in a height direction of the core. The air channels may be centrally located across a width direction of the core. At least some of the air channels may be centrally located between, and laterally spaced from, first and second pairs of the heater bores, wherein the first and second pairs are spaced from each other in the height direction of the core and in each of the first and second pairs the heater bores are spaced from each other in the width direction of the core and are located on respective opposite lateral sides of the core.

The continuous body can be assembled from a plurality of blocks of composite phase change material.

The phase change material can comprise a composite phase change material which comprises an inorganic material as a phase change composition, a structural material for structurally shape-stabilising the phase change material; and a heat transfer enhancement material dispersed in the phase change material. The structural material may comprise an alkaline earth metal oxide and the heat transfer enhancement material comprises graphite, carbide, metal or metal oxide, or a mixture of any two or more thereof.

### BRIEF DESCRIPTION OF THE FIGURES

Embodiments of the present invention will now be described by way of example only with reference to the accompanying drawings, in which:

FIG. 1 is a schematic diagram of the principal structure and function of an electric heater for thermal energy storage in accordance with an embodiment of the present invention;

FIG. 2 is a schematic front-side perspective view, partly in phantom, of an electric heater for thermal energy storage which incorporates the principal structure and function illustrated in FIG. 1;

FIG. 3 is a schematic front-side perspective view, partly in phantom, of the core and housing of the electric heater illustrated in FIG. 2;

FIG. 4 is a schematic end view, partly in phantom, of the core and housing of the electric heater illustrated in FIG. 2;

FIG. 5 is a schematic front-side perspective view of a gate mechanism in the housing of the electric heater illustrated in FIG. 2, the gate mechanism being in a closed, thermal charging configuration;

FIG. 6 is a schematic front-side perspective view of the gate mechanism of FIG. 5 in an open, thermal discharging configuration;

FIG. 7 is a schematic front view of the structure of the core and housing of the electric heater in accordance with a second embodiment of the present invention;

FIG. 8 is a schematic front view of the structure of the core and housing of the electric heater in accordance with a third embodiment of the present invention;

FIG. 9 is a schematic front view of the structure of the core and housing of the electric heater in accordance with a fourth embodiment of the present invention;

FIG. 10 is a schematic front view of the structure of the core and housing of the electric heater in accordance with a fifth embodiment of the present invention;

FIG. 11 is a graph showing the relationship between temperature and time, for both the phase change material and the electric heater elements, during thermal charging of an electric heater in accordance with a further embodiment of the present invention;

FIG. 12 is a schematic contour map of the temperature of a block of phase change material after thermal charging, the core being composed of an assembly of such blocks in an electric heater in accordance with a further embodiment of the present invention; and

FIG. 13 is a graph showing the relationship between temperature and time, for the phase change material, the output mixture of the inlet air flow and the outlet air flow from the core, and the external casing during thermal charging and subsequent thermal discharging of an electric heater in accordance with a further embodiment of the present invention.

### DETAILED DESCRIPTION

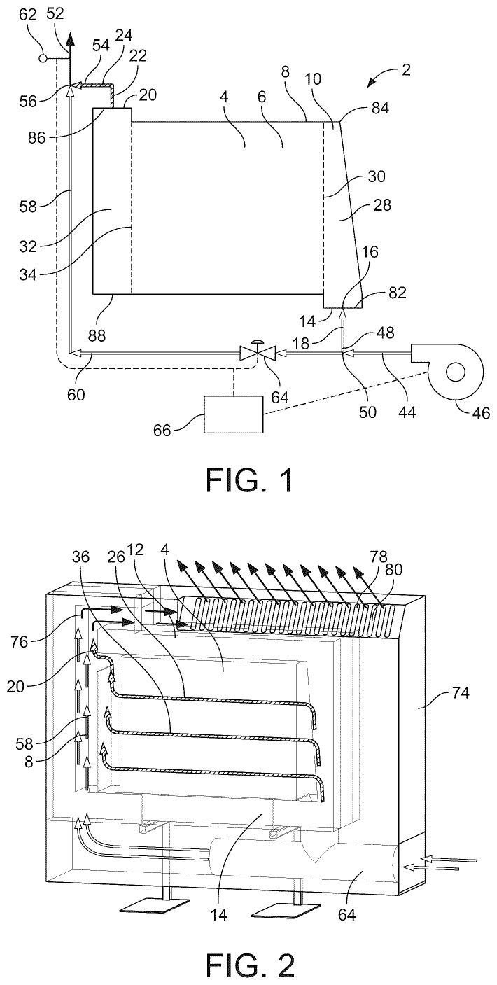

Referring to FIGS. 1 to 7, there is shown an electric heater 2 for thermal energy storage in accordance with a preferred embodiment of the present invention. The electric heater 2 comprises a core 4 comprising a phase change material 6. The phase change material 6 has a composition which absorbs or releases heat isothermally, or substantially isothermally, by transitioning, in a respective transition direction, between a first phase state and a second phase state at a predetermined transition temperature. For example, the first phase state is a solid state and the second phase state is a liquid state, and the predetermined transition temperature is the melting temperature, Tₘ, of the phase change material 6.

Typically, the phase change material 6 has a latent heat of from 100 to 800 KJ/kg, typically from 180 to 300 KJ/kg for the transition between the first and second phase states at the predetermined transition temperature. The predetermined transition temperature of the phase change material is within the range of from 200 to 850° C., typically from 400 to 600° C., for example within the range of from 450 to 550° C. The core 4 typically has an energy storage density of from 140 to 300 Wh/kg including sensible heat, for example from 160 to 250 Wh/kg including sensible heat, and an energy storage capacity of from 2 to 50 kWh.

Preferably, the phase change material 6 is a composite phase change material which comprises an inorganic material as a phase change composition, a structural material for structurally shape-stabilising the phase change material; and a heat transfer enhancement material dispersed in the phase change material. In one non-limiting embodiment of the present invention, the phase change material 6 comprises at least one inorganic salt or a mixture of a plurality of inorganic salts. The inorganic materials, typically alkali metal salts, may be selected from the group consisting of nitrates (e.g. NaNO₃, KNO₃ and LiNO₃), nitrites (e.g. NaNO₂ and KNO₂), carbonates (e.g. Na₂CO₃, Li₂CO₃, K₂CO₃), chlorides (e.g. KCl, NaCl), bromides (e.g. KBr, LiBr, NaBr, Li₂Br), fluorides (e.g. LiF, KF, NaF), sulphates (e.g. Na₂SO₄ and K₂SO₄), and hydroxides (e.g. NaOH, KOH, LiOH). Typically, when a mixture of PCMs is provided, for example when the PCMs are inorganic materials, the phase change material comprises a binary, ternary or quaternary eutectic mixture of individual phase change material components.

Typically, the structural material comprises an alkaline earth metal oxide, such as MgO, and the heat transfer enhancement material comprises graphite, carbides, metals, or metal oxides or a mixture of any two or more thereof.

Such a composite phase change material can exhibit a good cost-performance ratio, in particular to provide that the core 4 exhibits highly efficient thermal storage, with good thermal conductivity, and good physical and chemical stability of the composite phase change material, which can also be manufactured in a cost-effective manner.

A housing 8 surrounds the core 4 and defines a cavity 10 within which the core 4 is disposed. The housing 8 includes thermally insulating material 12 which at least partly surrounds the phase change material 6. The housing 8 has an air input opening 14 connected to an output end 16 of an air input conduit 18. The housing 8 also has an air output opening 20 connected to an input end 22 of an air output conduit 24. A first air path 26, shown in FIG. 2, extends through the core 4 between the air input opening 14 and the air output opening 20.

The housing 8 defines an input manifold 28, on an air input side 30 of the core 4, which is in communication with the air input opening 14, and an output manifold 32, on an air output side 34 of the core 4, which is in communication with the air output opening 20. As shown in FIG. 2, a plurality of air channels 36 extend through the core 4 between the input and output manifolds 28, 32 to form the first air path 26.

As shown in FIGS. 2 to 4, the air channels 36 form an array of parallel air channels 36. The air channels 36 are horizontally oriented and are mutually spaced in a height direction (H) of the core 4. The air channels 36 are centrally located across a width direction (W) of the core 4.

At least some, and in the illustrated embodiment each, of the air channels 36 are located between, and laterally spaced from, a plurality of heater bores 38 which are located, in the width direction (W) of the core 4, on respective opposite sides of the air channel 36 and are spaced along the height direction (H) of the core 4.

In the illustrated embodiment, the air channels 36 are centrally located between, and laterally spaced from, first and second pairs 38a, 38b; 38c, 38d of the heater bores. The first and second pairs 38a, 38b; 38c, 38d of the heater bores are spaced from each other in the height direction (H) of the core 4 and in each of the first and second pairs 38a, 38b; 38c, 38d the heater bores are spaced from each other in the width direction (W) of the core 4 and are located on respective opposite lateral sides 5a, 5b of the core 4. Consequently, in this embodiment each air channel 36 is located at a geometric centre of a quadrilateral polygon having a shape and dimensions defined the positions of four heater bores 38. However, other configurations for positioning the air channels 36 relative to the heater bores 38 may be employed.

An electric heater element 40 is received with and extends along each respective heater bore 38a, so that a plurality of the electric heater elements 40 are positioned within the core 4 for heating the core 4 to charge the core 4 with stored thermal energy by transitioning the phase change material from the first phase state to the second phase state. For clarity of illustration, a pair of opposed electric heater elements 40 are shown in one pair of heater bores 38b in FIG. 4, but as described above each heater bore 38 receives a respective electric heater element 40. Preferably, the heater elements 40 are in direct contact with, or are immersed in, the phase change material (PCM) 6 of the core 4, which enhances heat transfer rate between the heater elements 40 and the phase change material (PCM) 6 and reduces the charging time.

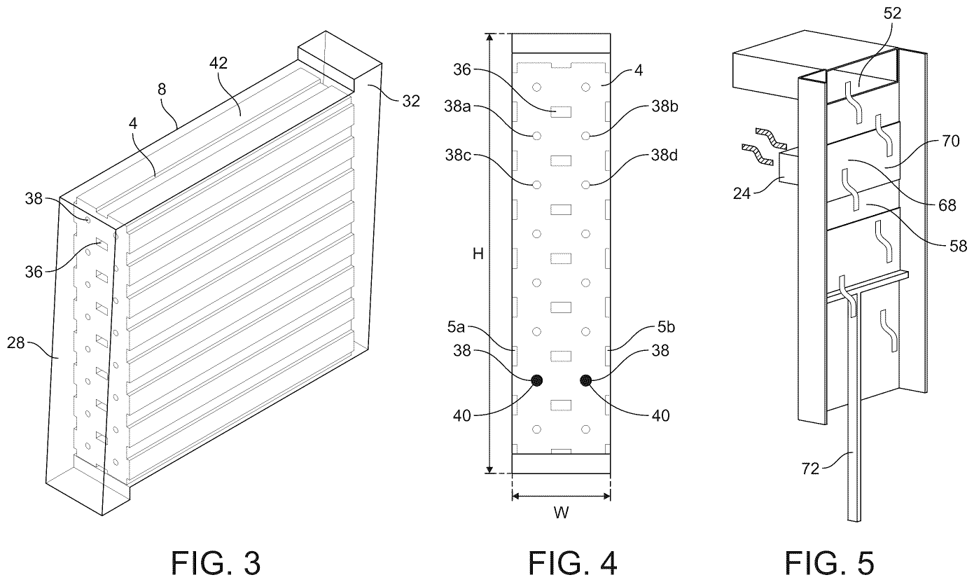

In the illustrated embodiment, as shown in FIGS. 3 and 4 the core 4 is formed as a continuous body 42 with only the air channels 36 and heater bores 38 extending through the continuous body 42. Preferably, the continuous body 42 is assembled from a plurality of blocks of phase change material 6. Since the phase change material 6 transitions from the solid state to the liquid state during thermal charging, each block comprises a body of the phase change material 6 within an outer case which seals the phase change material 6 within the block to avoid leakage of the phase change material 6 during successive thermal charging/thermal discharging cycles.

An air supply conduit 44 is, in use, connected to a supply of an external air flow and an air blower 46 is fitted to the air supply conduit 44 for blowing the external air flow into the air supply conduit 44. An inlet end 48 of the air input conduit 18 is connected to the air supply conduit 44 at a first junction 50.

A heated air outlet conduit 52 for outputting heated air from the electric heater 2 is provided. An outlet end 54 of the air output conduit 24 is connected to the heated air outlet conduit 52 at a second junction 56.

A bypass conduit 58 connects the first and second junctions 50, 56 and defines a second air path 60 external of the core 4.

In the illustrated embodiment, the second junction 56 is located at an upper corner of the electric heater 2. However, in alternative embodiments, the second junction 56 may be located at an alternative position, for example at a bottom edge of the electric heater 2. By providing the second junction 56 at a bottom edge of the electric heater 2, the insulation of the core may be improved and the electric heater 2 may exhibit reduced heat losses.

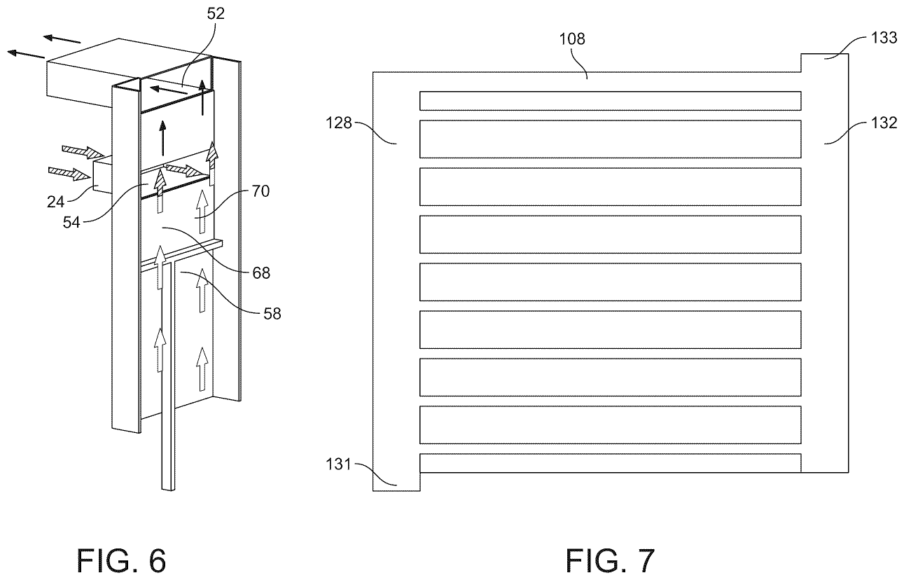

Referring FIGS. 5 and 6, a gate mechanism 68 at the second junction 56 is configured to be switched between a thermal charging configuration shown in FIG. 5 and a thermal discharging configuration shown in FIG. 6. In the thermal charging configuration, the outlet end 54 of the air output conduit 24 is closed, or substantially closed, and the heated air outlet conduit 52 only, or primarily receives air flow from the bypass conduit 58. In the thermal discharging configuration, the outlet end 54 of the air output conduit 24 is open and the heated air outlet conduit 52 receives a mixed air flow from the air output conduit 24 and the bypass conduit 58. In a thermal discharge phase, air flowing through the air channels 36 is heated by the core 4.

The gate mechanism 68 may also be configured to be disposed at an intermediate position, not shown in the Figures, which partly closes the outlet end 54 of the air output conduit 24 so that the core can be simultaneously thermally charged and thermally discharged. The degree of closure/opening of the outlet end 54 of the air output conduit 24 can be varied across a desired range, and this range can be continuous or indexed, to enable the thermal storage/thermal output to be varied as desired. The gate mechanism 68 can be configured to cause the outlet end 54 of the air output conduit 24 to be continuously open by at least a minimum threshold amount, so that the electric heater 2 is capable of continuous thermal discharge, at least at a minimum output level, if required. Consequently, in this specification, the description that the outlet end 54 of the air output conduit 24 is “closed”, is intended to encompass a first arrangement in which a minimum opening is nevertheless provided so that the outlet end 54 of the air output conduit 24 is substantially closed and the heated air outlet conduit 52 primarily receives air flow from the bypass conduit 58, or an alternative second arrangement, illustrated in FIG. 5, in which the outlet end 54 of the air output conduit 24 is fully closed and the heated air outlet conduit 52 only receives air flow from the bypass conduit 58.

The gate mechanism 68 comprises a slidable plate 70 which is controlled by an actuator 72 and is configured to be translationally slid between a first translational position in the thermal charging configuration to cover the outlet end 54 of the air output conduit 24 and a second translational position in the thermal discharging configuration to expose the outlet end 54 of the air output conduit 24. As described above, the slidable plate 70 may be controlled so as to be movable between the first and second translational positions, and to be disposed at an intermediate position to permit simultaneous thermal charging and discharging. Also, in the first translational position, the outlet end 54 of the air output conduit 24 may be substantially closed to permit at least a minimum thermal discharge to be continuously conducted.

A temperature sensor 62 is provided for sensing the temperature of heated air in the heated air outlet conduit 52, or downstream of the heated air outlet conduit 52 in the direction of air flow through the heated air outlet conduit 52. An air flow control valve mechanism 64 is provided in at least one of the bypass conduit 58 and the air input conduit 18 for controlling a flow rate of air flow along the bypass conduit 58 and/or the air input conduit 18 based on the temperature of the heated air measured by the temperature sensor 62. In the illustrated embodiment, the air flow control valve mechanism 64 is provided in the bypass conduit 58 to control the flow rate of air flow along the bypass conduit 58.

By controlling the flow rate of air flow along the bypass conduit 58 and/or the air input conduit 18, the ratio of the volume flow rate of air along the first and second air paths is variably controlled. The temperature sensor 62 is controllable to vary the output temperature of the heated air outputted from the heated air outlet conduit 52 of the electric heater 2 during a thermal discharging operation.

As shown in FIG. 2, an external casing 74 encloses at least the housing 8, the bypass conduit 58 and the valve mechanism 64. The external casing 74 comprises an air duct 76 in communication with the heated air outlet conduit 52, and an array of air outlet vents 78 in the external casing 74 form an air outlet 80 of the air duct 76.

A controller 66 is electrically connected (as shown schematically by dashed lines in FIG. 1) to the temperature sensor 62, the air flow control valve mechanism 64 and the air blower 46. The controller 66 is also electrically connected to the actuator 72 of the gate mechanism 68. The controller 66 can be thermostatically controlled to set the output temperature of the electric heater 2 to a desired temperature. The controller 66 receives a temperature signal from the temperature sensor 62 and sends an actuation signal to the air flow control valve mechanism 64. The controller 66 operates the air blower 46, and opens the gate mechanism 68, during a thermal discharging operation. Accordingly, the output temperature of the heated air outputted from the electric heater 2 can be thermostatically controlled during thermal discharge.

The input manifold 28 has a first end 82 adjacent to the air input opening 14 and a second end 84 remote from the air input opening 14 along a length direction of the input manifold 28. Between the first and second ends 82, 84 of the input manifold 28, the input manifold 28 successively communicates with the plurality of air channels 36 which are spaced along the length of the input manifold 28. The output manifold 32 has a first end 86 adjacent to the air output opening 20 and a second end 88 remote from the air output opening 20 along a length direction of the output manifold 32. Between the first and second ends 86, 88 of the output manifold 32, the output manifold 32 successively communicates with the plurality of air channels 36 which are spaced along the length of the output manifold 32.

In the illustrated embodiment shown in FIGS. 1 and 2, the first end 82 of the input manifold 28 is lower than the second end 84 of the input manifold 28, and the first end 86 of the output manifold 32 is higher than the second end 88 of the output manifold 32. In this arrangement, the air flow enters the housing 8 at a bottom corner on one upright edge of the housing 8 and exits the housing 8 at a top corner on the opposite upright edge of the housing 8.

Furthermore, in the illustrated embodiment shown in FIGS. 1 and 2, the input manifold 28 progressively decreases in depth, in a direction transverse to the length direction of the input manifold 28, from the first to second ends 82, 84 of the input manifold 28. In contrast, the output manifold 32 has a constant depth, in a direction transverse to the length direction of the output manifold 32, from the second to first ends 88, 86 of the output manifold 32.

In an alternative embodiment shown in FIG. 7, the input manifold 128 and the output manifold 132 each have a constant depth in a direction transverse to the length direction of, and along the length of, the respective manifold 128, 132. In this alternative embodiment, the air flow enters the housing 108 at a bottom corner on one upright edge of the housing 108 and exits the housing 108 at a top corner on the opposite upright edge of the housing 108.

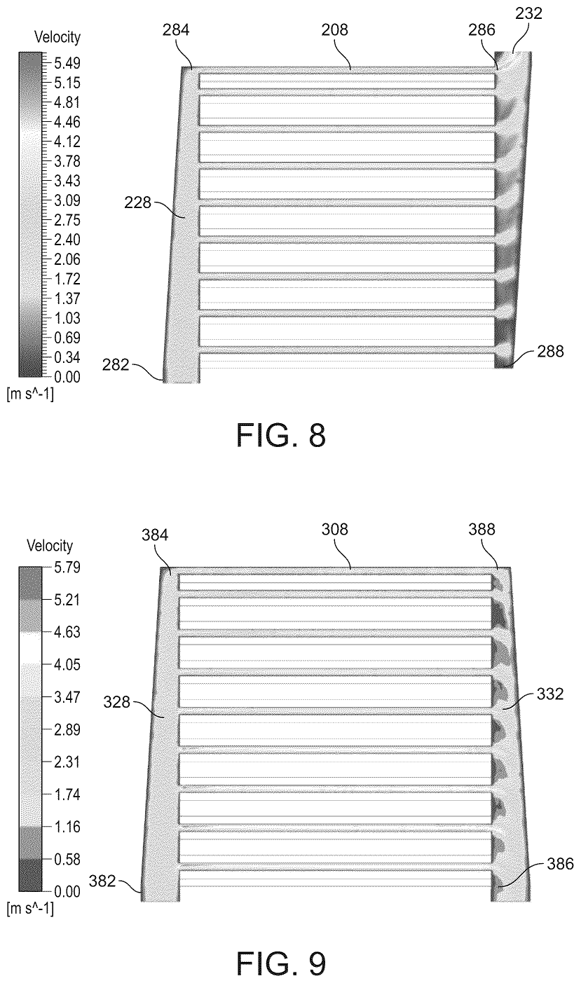

In a further alternative embodiment shown in FIG. 8, the input manifold 228 progressively decreases in depth, in a direction transverse to the length direction of the input manifold 228, from the first to second ends 282, 284 of the input manifold 228, and the output manifold 232 progressively increases in depth, in a direction transverse to the length direction of the output manifold 232, from the second to first ends 288, 286 of the output manifold 232. The air flow enters the housing 208 at a bottom corner on one upright edge of the housing 208 and exits the housing 208 at a top corner on the opposite upright edge of the housing 208. A velocity contour of the air flow through the housing 208 is shown in FIG. 8.

In a yet further alternative embodiment shown in FIG. 9, the first end 382 of the input manifold 328 is lower than the second end 384 of the input manifold 328, and the first end 386 of the output manifold 332 is lower than the second end 388 of the output manifold 332. The input manifold 328 progressively decreases in depth, in a direction transverse to the length direction of the input manifold 328, from the first to second ends 382, 384 of the input manifold 328, and the output manifold 332 progressively increases in depth, in a direction transverse to the length direction of the output manifold 332, from the second to first ends 388, 386 of the output manifold 332. The air flow enters the housing 308 at a bottom corner on one upright edge of the housing 308 and exits the housing 308 at a bottom corner on the opposite upright edge of the housing 308. A velocity contour of the air flow through the housing 308 is shown in FIG. 9.

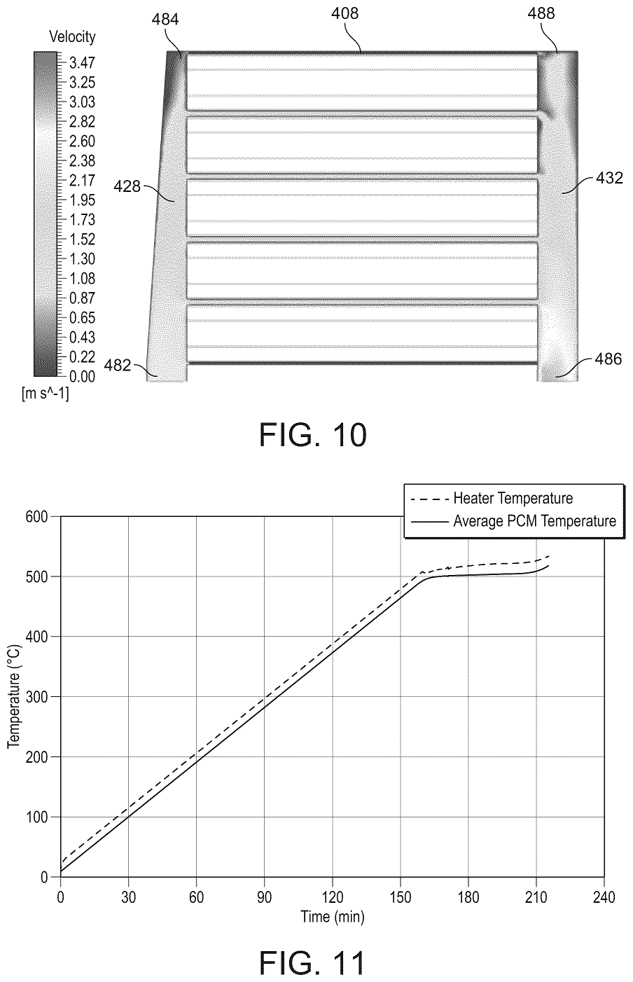

In a still further alternative embodiment shown in FIG. 10, the first end 482 of the input manifold 428 is lower than the second end 484 of the input manifold 428, and the first end 486 of the output manifold 432 is lower than the second end 488 of the output manifold 432. The input manifold 428 progressively decreases in depth, in a direction transverse to the length direction of the input manifold 428, from the first to second ends 482, 484 of the input manifold 428, and the output manifold 432 has a constant depth in a direction transverse to the length direction of the output manifold 432. The air flow enters the housing 408 at a bottom corner on one upright edge of the housing 408 and exits the housing 408 at a bottom corner on the opposite upright edge of the housing 408. A velocity contour of the air flow through the housing 408 is shown in FIG. 10.

Referring to FIG. 11, this graph shows the relationship between temperature and time during thermal charging of the electric heater 2 shown in FIGS. 1 to 7. In particular, a first plot shows the increase in heater temperature (i.e. the temperature of the electric heater elements 40) and a second plot shows the increase in core temperature (i.e. average temperature of the phase change material) over time during charging. These two plots are closely aligned and have the same heating rate up to a temperature of over 500° C., which shows that the phase change material is being uniformly heated by the electric heater elements. At a temperature of about 500° C., the heating rate of the phase change material, and correspondingly the electric heater elements, is significantly reduced, which shows that the phase change material has passed the transition temperature (i.e. Tₘ) and is transitioning from a solid phase to a liquid phase, and further thermal energy is absorbed by the phase change material in the form of latent heat. The total charging time was about 210 minutes.

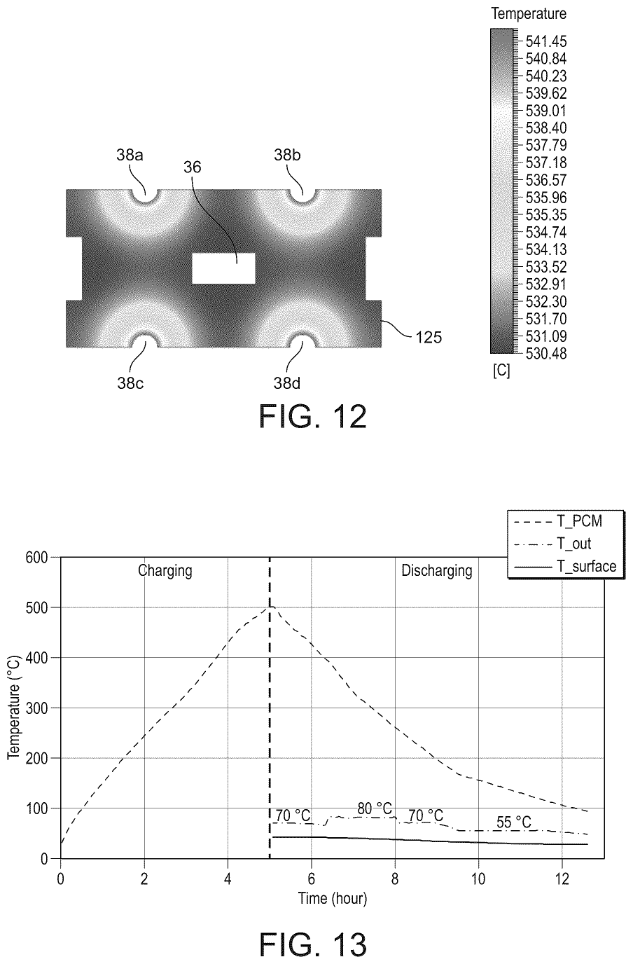

In the illustrated embodiment, the construction of the core in the form of the continuous body formed from assembled bocks, with only the air channels and heater bores extending through the continuous body. FIG. 12 shows the temperature contour of a single block 125, which comprises phase change material, after thermal charging. It may be seen that the configuration of the air channel 36 and heater bores 38a, 38b; 38c, 38d, provides the advantage that the core is uniformly heated and any temperature difference between the hottest and coldest parts of the core is only about 30° C. when the core is fully heated to a temperature of more than 500° C. The arrangement of the air channels and heater bores in a continuous body of the core comprising phase change material provides enhanced, more uniform and more efficient thermal energy storage by the core.

Referring to FIG. 13, this graph shows the relationship between temperature and time during thermal charging and subsequent thermal discharging of another example of the electric heater 2 shown in FIGS. 1 to 7. The electric heater was operated in ambient conditions simulating a domestic installation and the temperature of the inlet air (i.e. air which is input to be conveyed along the bypass conduit and the second air path) was initially at ambient temperature, i.e. 20° C. In FIG. 13, a first plot (T_PCM) shows the average temperature of the phase change material in the core; a second plot (T_out) shows the temperature of the mixed output air (i.e. air which is mixed from the first and second air paths and is outputted from the electric heater); and a third plot (T_surface) shows the surface temperature of the external casing of the electric heater.

It may be seen that during thermal charging, the average temperature of the phase change material in the core increased up to a temperature of about 500° C. over a total charging time of about 5 hours. Although not shown in FIG. 13, during charging, the inlet air (i.e. air which is input and conveyed along the bypass conduit 58 and the second air path 60) had a substantially constant temperature of about 20° C. (ambient temperature) and the temperature at the outlet from the core (i.e. air which is at the output of the first air path 26, which is closed during charging) was slowly increased to about 70° C., which is believed to be caused by thermal conduction from the heated core.

Prior to discharging, the controller was set to thermostatically control the desired output temperature to a value of 70° C. for the heated air flow output from the electric heater.

Upon discharging, which is initiated by opening the gate mechanism and starting operation of the air blower to force air flow through the core, the temperature of the phase change material was smoothly reduced over a discharge period of about 8 hours.

The air flow from the first air path 26 through the core was mixed with the air flow from the second air path 60 through the bypass conduit 58, and the mixed air flow, which temperature was detected by the temperature sensor 62 which is used, together with the controller 66, to thermostatically control the desired output temperature, had an output temperature of about 70° C. This desired output temperature of about 70° C. was substantially constantly maintained by the electric heater over an initial discharge period of about 75 minutes. Then the controller was operated to adjust the desired output temperature to different set temperatures over different successive time periods in order to simulate a domestic installation in which the user may desire to control the output temperature at different times during the daytime dependent on ambient weather conditions and room usage; in particular, the electric heater was thermostatically controlled to have an output temperature of 80° C. for a period of about 105 minutes, then an output temperature of 70° C. again for a further period of about 75 minutes, and finally an output temperature of 55° C. for a period of about 180 minutes.

It may be seen that the desired thermostatically controlled output temperatures could be reliably and accurately achieved, and that the electric heater was capable of increasing or decreasing the output temperature upon demand over a rapid transition period. These thermostatically controlled output temperature transitions were achieved over an extended discharge period, throughout which the temperature of the phase change material was decreasing from an initial temperature of about 500° C. to a final temperature, after the discharge period of about 8 hours, of about 100° C.

FIG. 13 also shows that while the output temperature of the mixed air output can readily be varied, the temperature of the external casing can be maintained at a substantially constant temperature of about 30° C. Accordingly, the electric heater can be provided with sufficient thermal insulation so that the external casing is maintained at a constant safe temperature, despite the electric heater containing the PCM core, which may be at a very high temperature, for example of about 500° in this example, and despite higher variable output temperatures.

In other embodiments, the desired output temperature can be thermostatically set by the controller at a different temperature; for example, for a typical domestic storage heater would set an output temperature of about 33-55° C.

The graph of FIG. 13 shows that the electric storage heater according to the invention can use a phase change material in an electric storage heater and achieve controlled thermal discharge at a substantially constant pre-set temperature, which can be varied under thermostatic control, over an extended discharge period of about 8 hours.

As compared to known electric storage heaters, which use bricks composed of a refractory material to store thermal energy, the electric storage heaters according to the invention can have a significantly reduced weight and cost for a given thermal storage capacity. For example, for a typical storage capacity of about 10 kWh for a domestic storage heater, the electric storage heaters according to the invention typically have a weight of about 60 kg, which is significantly lighter in weight, for example at least 30% lighter in weight, than known commercial domestic storage heaters. By using a phase change material, which stories additional thermal energy in the form of latent heat as compared to a solid refractory material, the weight required for a given thermal energy storage capacity is reduced. The energy storage density of an electric storage heater according to the invention is typically at least 27% higher than that of known commercial domestic storage heaters.

Furthermore, the amount of a typical composite phase change material required for such a domestic storage heater has a significantly lower cost, typically about 50% lower, than the cost of the corresponding amount of solid refractory material for the same given thermal energy storage capacity.

Therefore, the present invention can provide electric storage heaters, using a phase change material as a thermal energy storage medium, which can exhibit enhanced performance, including a thermostatically controllable constant output temperature over an extended discharge period and a higher energy storage density, and a lower manufacturing cost, than known commercial domestic storage heaters using a solid refractory material as the thermal energy storage medium.

Various modifications to the illustrated embodiments as described hereinabove will be apparent to those skilled in the art and are intended to be included within the scope of the present invention as defined by the appended claims.

We claim:

1. An electric heater for thermal energy storage, the electric heater comprising:
(i) a core comprising a phase change material having a composition which absorbs or releases heat isothermally, or substantially isothermally, by transitioning, in a respective transition direction, between a first phase state and a second phase state at a predetermined transition temperature;
(ii) a plurality of electric heater elements positioned within the core for heating the core to charge the core with stored thermal energy by transitioning the phase change material from the first phase state to the second phase state;
(iii) a housing surrounding the core and defining a cavity within which the core is disposed, the housing having an air input opening connected to an output end of an air input conduit and an air output opening connected to an input end of an air output conduit, and a first air path extending through the core between the air input opening and the air output opening;
(iv) an air supply conduit for connection to a supply of an external air flow, wherein an inlet end of the air input conduit is connected to the air supply conduit at a first junction;
(v) a heated air outlet conduit for outputting heated air from the electric heater, wherein an outlet end of the air output conduit is connected to the heated air outlet conduit at a second junction;
(vi) a bypass conduit connecting the first and second junctions and defining a second air path external of the core;
(vii) a temperature sensor for sensing the temperature of heated air in the heated air outlet conduit, or downstream of the heated air outlet conduit in the direction of air flow through the heated air outlet conduit; and
(viii) an air flow control valve mechanism in at least one of the bypass conduit and the air input conduit for variably controlling a flow rate of air flow along the bypass conduit and/or the air input conduit based on the temperature of the heated air measured by the temperature sensor, thereby variably to control the ratio of the volume flow rate of air along the first and second air paths.

2. The electric heater according to claim 1, wherein the housing defines an input manifold, on an air input side of the core, which is in communication with the air input opening, and an output manifold, on an air output side of the core, which is in communication with the air output opening, and a plurality of air channels extend through the core between the input and output manifolds to form the first air path.

3. The electric heater according to claim 2, wherein the air channels form an array of parallel air channels.

4. The electric heater according to claim 2, wherein the air channels are horizontally oriented and are mutually spaced in a height direction of the core.

5. The electric heater according to claim 2, wherein the air channels are centrally located across a width direction of the core.

6. The electric heater according to claim 2, wherein the core comprises a plurality of heater bores which extend along the core, and a respective one of the electric heater elements is received in and extends along each respective heater bore, wherein at least some of the air channels are located between, and laterally spaced from, a plurality of the heater bores which are located, in a width direction of the core, on respective opposite lateral sides of the air channel and are spaced along a height direction of the core.

7. The electric heater according to claim 6, wherein at least some of the air channels are centrally located between, and laterally spaced from, first and second pairs of the heater bores, wherein the first and second pairs are spaced from each other in the height direction of the core and in each of the first and second pairs the heater bores are spaced from each other in the width direction of the core and are located on respective opposite lateral sides of the core, and wherein the core is formed as a continuous body with only the air channels and heater bores extending through the continuous body.

8. The electric heater according to claim 7, wherein the continuous body is assembled from a plurality of blocks of phase change material.

9. The electric heater according to claim 2, wherein the input manifold has a first end adjacent to the air input opening and a second end remote from the air input opening along a length direction of the input manifold, and, between the first and second ends of the input manifold, the input manifold successively communicates with the plurality of air channels which are spaced along the length of the input manifold, and the output manifold has a first end adjacent to the air output opening and a second end remote from the air output opening along a length direction of the output manifold, and, between the first and second ends of the output manifold, the output manifold successively communicates with the plurality of air channels which are spaced along the length of the output manifold.

10. The electric heater according to claim 9 wherein
the first end of the input manifold is lower than the second end of the input manifold, and the first end of the output manifold is higher than the second end of the output manifold, or
the first end of the input manifold is lower than the second end of the input manifold, and the first end of the output manifold is lower than the second end of the output manifold, and/or wherein
the input manifold progressively decreases in depth, in a direction transverse to the length direction of the input manifold, from the first to second ends of the input manifold, and the output manifold progressively increases in depth, in a direction transverse to the length direction of the output manifold, from the second to first ends of the output manifold, or
the input manifold progressively decreases in depth, in a direction transverse to the length direction of the input manifold, from the first to second ends of the input manifold, and the output manifold has a constant depth, in a direction transverse to the length direction of the output manifold, from the second to first ends of the output manifold, or
the input manifold has a constant depth, in a direction transverse to the length direction of the input manifold, from the first to second ends of the input manifold, and the output manifold has a constant depth, in a direction transverse to the length direction of the output manifold, from the second to first ends of the output manifold.

11. The electric heater according to claim 1 further comprising a gate mechanism at the second junction, wherein the gate mechanism is configured to be switched between a thermal charging configuration, in which the outlet end of the air output conduit is closed, or substantially closed, and the heated air outlet conduit only, or primarily, receives air flow from the bypass conduit, and a thermal discharging configuration, in which the outlet end of the air output conduit is open and the heated air outlet conduit receives a mixed air flow from the air output conduit and the bypass conduit.

12. The electric heater according to claim 11, wherein the gate mechanism is at least one of:
configured to be switchable to an intermediate configuration which partly closes the outlet end of the air output conduit so that the core can be simultaneously thermally charged and thermally discharged, and the degree of closure and opening of the outlet end of the air output conduit can be varied across a desired range to enable the thermal storage and thermal output to be varied as desired,
configured to cause the outlet end of the air output conduit to be continuously open by at least a minimum threshold amount, so that when the outlet end of the air output conduit is substantially closed, the electric heater is capable of continuous thermal discharge at least at a minimum output level, or
comprises a slidable plate which is controlled by an actuator and is configured to be translationally slid between a first translational position in the thermal charging configuration to at least substantially cover the outlet end of the air output conduit and a second translational position in the thermal discharging configuration to expose the outlet end of the air output conduit.

13. The electric heater according to claim 1, wherein the housing includes thermally insulative material which at least partly surrounds the phase change material.

14. The electric heater according to claim 1 further comprising an air blower fitted to the air supply conduit for blowing the external air flow into the air supply conduit, and a controller for operating the air blower during a thermal discharging operation.

15. The electric heater according to claim 1, wherein the temperature sensor is controllable to vary the output temperature of the heated air outputted from the electric heater during a thermal discharging operation.

16. The electric heater according to claim 1 further comprising an external casing which encloses at least the housing, the bypass conduit and the valve mechanism, and the external casing comprises an air duct in communication with the heated air outlet conduit, and an array of air outlet vents in the external casing which form an air outlet of the air duct.

17. The electric heater according to claim 1, wherein at least one of
the phase change material has a latent heat of from 100 to 800 KJ/kg, optionally from 180 to 300 KJ/kg, for the transition between the first and second phase states at the predetermined transition temperature,
the core has an energy storage density of from 140 to 300 Wh/kg, optionally from 160 to 250 Wh/kg,
the core has an energy storage capacity of from 2 to 50 kWh, or
the predetermined transition temperature of the phase change material is within the range of from 200 to 750° C., optionally within the range of from 300 to 750° C.

18. The electric heater according to claim 1, wherein the phase change material is a composite phase change material which comprises an inorganic material as a phase change composition, a structural material for structurally shape-stabilising the phase change material; and a heat transfer enhancement material dispersed in the phase change material.

19. The electric heater according to claim 18, wherein the structural material comprises an alkaline earth metal oxide and the heat transfer enhancement material comprises graphite, carbide, metal or metal oxide, or a mixture of any two or more thereof.

20. A thermal energy storage for an electric heater, comprising:
(i) a core comprising a phase change material having a composition which absorbs or releases heat isothermally, or substantially isothermally, by transitioning, in a respective transition direction, between a first phase state and a second phase state at a predetermined transition temperature;
(ii) a plurality of electric heater elements positioned within the core for heating the core to charge the core with stored thermal energy by transitioning the phase change material from the first phase state to the second phase state;
(iii) a plurality of air channels extending through the core between opposite input and output sides of core to form an air path through the core for heating air flowing through the air channels in a thermal discharge phase; and
(iv) a plurality of heater bores which extend along the core, a respective one of the electric heater elements being received in and extending along each respective heater bore, wherein at least some of the air channels are located between, and laterally spaced from, a plurality of the heater bores which are located, in a width direction of the core, on respective opposite lateral sides of the air channel and are spaced along a height direction of the core, and the core is formed as a continuous body with only the air channels and heater bores extending through the continuous body.

21. The thermal energy storage according to claim 20, wherein the air channels at least one of:
form an array of parallel air channels,
are horizontally oriented and are mutually spaced in a height direction of the core, or are centrally located across a width direction of the core.

22. The thermal energy storage according to claim 20, wherein at least some of the air channels are centrally located between, and laterally spaced from, first and second pairs of the heater bores, wherein the first and second pairs are spaced from each other in the height direction of the core and in each of the first and second pairs the heater bores are spaced from each other in the width direction of the core and are located on respective opposite lateral sides of the core.

23. The thermal energy storage according to claim 20, wherein the continuous body is assembled from a plurality of blocks of composite phase change material.

24. The thermal energy storage according to claim 20, wherein the phase change material is a composite phase change material which comprises an inorganic material as a phase change composition, a structural material for structurally shape-stabilising the phase change material; and a heat transfer enhancement material dispersed in the phase change material.

25. The thermal energy storage according to claim 24, wherein the structural material comprises an alkaline earth metal oxide and the heat transfer enhancement material comprises graphite, carbide, metal or metal oxide, or a mixture of any two or more thereof.
